(19) United States
(12) Patent Application Publication
(10) Pub. No.: US 2024/0273826 A1
(43) Pub. Date: Aug. 15, 2024

(54) VIRTUAL SPACE PRODUCTION APPARATUS

(71) Applicant: HONDA MOTOR CO., LTD., Tokyo (JP)

(72) Inventors: Kazuya KONADA, Wako-shi (JP); Takashi YANAGI, Wako-shi (JP); Ryosuke YAMAZAKI, Wako-shi (JP)

(21) Appl. No.: 18/439,933

(22) Filed: Feb. 13, 2024

(30) Foreign Application Priority Data
Feb. 14, 2023 (JP) 2023-021090

(51) Int. Cl. G06T 19/00; G06F 3/01

(52) U.S. Cl. CPC G06T 19/00; G06F 3/011

(57) ABSTRACT

A virtual space production apparatus includes: an audio visual (AV) device configured to provide AV information to an occupant of a moving body; an SUS actuator configured to generate load relating to vibration of the moving body; a VR controller configured to control the AV device and the SUS actuator; an information obtainer configured to obtain tilt information indicating the tilt angle of the moving body; and a determiner configured to determine whether or not the moving body is in a tilted state where the moving body is tilted greater than a predetermined tilt angle threshold, based on the tilt information indicating the tilt angle of the moving body. When the moving body is tilted greater than the predetermined first tilt angle threshold, the VR controller reduces a drive amount of the SUS actuator to an amount smaller than that in a normal state where the moving body is not in the tilted state.

### CROSS-REFERENCE TO RELATED APPLICATION

This application is based upon and claims priority from the Japanese Patent Application No. 2023-021090, filed on Feb. 14, 2023, the entire contents of which are incorporated herein by reference.

### BACKGROUND OF THE INVENTION

### 1. Field of the Invention

The present invention relates to a virtual space production apparatus configured to build a virtual space in a cabin of a moving body such as a vehicle to produce a simulated experience for an occupant.

### 2. Description of the Related Art

Conventionally, there is known a technique in which a virtual space is built in a vehicle cabin by using the vehicle as a motion platform to produce a simulated experience for an occupant (see, for example, JP2017-102401A).

A virtual reality system according to JP2017-102401A includes video presenting means for presenting a video to a user based on video information expressing the virtual space and controlling means for controlling acceleration and deceleration of the vehicle by using a drive pattern that causes the vehicle to move, then stop, and return to the original position such that sense or motion corresponding to the video information expressing the virtual space is presented.

According to the virtual reality system in JP2017-102401A, the sense or motion corresponding to the video information can be presented to the user by using the vehicle as the motion platform.

### SUMMARY OF THE INVENTION

However, in the virtual reality system according to JP2017-102401A, for example, when a virtual reality (hereinafter, abbreviated as VR in some cases) service in which the sense or motion corresponding to the video information is presented to the user is provided in the virtual space built in the vehicle cabin by using the stopped vehicle as the motion platform, the vehicle sometimes greatly shakes due to the provision of the VR service. If a person passes by the vehicle in such a case, there is a concern of occurrence of a situation where the vehicle providing the VR service comes into contact with the passerby.

The present invention has been made in view of the above circumstances, and an object is to provide a virtual space production apparatus as follows: even when a moving body such as a vehicle is in a stopped state on a sloped road while providing a VR service, the virtual space production apparatus can prevent contact between the moving body and the object in advance.

A virtual space production apparatus according to the present invention to achieve the above-mentioned object is primarily characterized in that the virtual space production apparatus includes: an audio visual (AV) device configured to provide AV information to an occupant of a moving body; an actuator configured to generate load relating to vibration of the moving body; and a controller configured to control the AV device and the actuator, in which the virtual space production apparatus produces a simulated experience for the occupant in a virtual space by driving the AV device and the actuator when providing a virtual reality (VR) service by using the moving body in a stopped state, the virtual space production apparatus further including: an information obtainer configured to obtain tilt information indicating tilt angle of the moving body, a determiner configured to determine whether or not the moving body is in a tilted state where the moving body is tilted greater than a predetermined tilt angle threshold based on the tilt information obtained by the information obtainer; wherein when the determiner determines that the moving body is in the tilted state where the moving body is tilted greater than the predetermined tilt angle threshold, the controller reduces a drive amount of at least the actuator out of the AV device and the actuator to an amount smaller than a drive amount in a normal state where the moving body is not in the tilted state.

According to the present invention, even when a moving body such as a vehicle is in a stopped state on a sloped road while providing a VR service, contact between the moving body and the object can be prevented in advance.

### BRIEF DESCRIPTION OF THE DRAWINGS

FIG. 1 is a schematic configuration diagram of a virtual space production apparatus according to an embodiment of the present invention.

FIG. 2 is a schematic configuration diagram of a vehicle to which the virtual space production apparatus is applied.

FIG. 3A is a diagram used to explain operations according to an example of the virtual space production apparatus in the case where a vehicle is parked on a tilted road.

FIG. 3B is a diagram used to explain the operations according to the example of the virtual space production apparatus in the case where the vehicle is parked on the tilted road.

FIG. 4A is a diagram used to explain operations according to the example of the virtual space production apparatus in the case where a passerby is present in a monitoring region of the vehicle after transition to a VR mode.

FIG. 4B is a diagram used to explain the operations according to the example of the virtual space production apparatus in the case where the passerby is present in the monitoring region of the vehicle after the transition to the VR mode.

FIG. 4C is a diagram used to explain operations according to the example of the virtual space production apparatus in the case where a determination result of presence or absence of the passerby in the monitoring region of the vehicle is reversed after the transition to the VR mode.

FIG. 5A is a flowchart used to explain operations of the virtual space production apparatus.

FIG. 5B is a flowchart used to explain operations of the virtual space production apparatus.

FIG. 6A is a diagram used to explain operations according to a first modified example of the virtual space production apparatus in the case where the passerby is present in the monitoring region of the vehicle after the transition to the VR mode.

FIG. 6B is a diagram used to explain the operations according to the first modified example of the virtual space production apparatus in the case where the passerby is present in the monitoring region of the vehicle after the transition to the VR mode.

### DETAILED DESCRIPTION OF THE EMBODIMENTS

A virtual space production apparatus 11 according to an embodiment of the present invention is described below in detail with reference to the drawings as appropriate.

Note that, in the drawings described below, members with common functions are denoted by common reference numerals. In this case, overlapping description is omitted in principle. Moreover, the sizes and shapes of the members are sometimes schematically expressed in a deformed or exaggerated manner for the sake of explanation.

[Outline of Virtual Space Production Apparatus 11 According to Embodiment of Present Invention]

First, an outline of the virtual space production apparatus 11 according to the embodiment of the present invention is described.

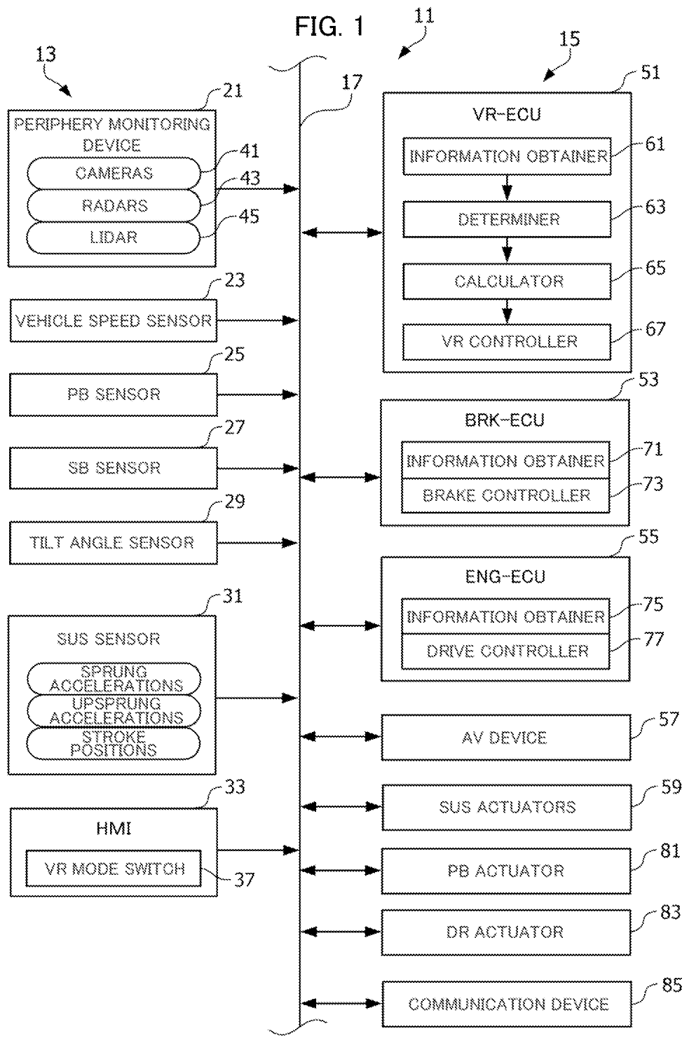

The virtual space production apparatus 11 according to the embodiment of the present invention includes an audio visual (AV) device 57 (see FIG. 1) configured to provide AV information to an occupant of a moving body such a vehicle 10, an actuator (see “SUS actuators 59” shown in FIG. 1) configured to generate load relating to vibration of the moving body, and a controller (see “VR controller 67” shown in FIG. 1) configured to control the AV device 57 and the SUS actuators 59, and is a virtual space production apparatus that produces simulated experience for the occupant in a virtual space by driving the AV device 57 and the SUS actuators 59 when providing a virtual reality (VR) service. The virtual space production apparatus 11 further includes an information obtainer 61 (see FIG. 1) configured to obtain tilt information indicating tilt angle of the moving body (vehicle 10) and a determiner 63 (see FIG. 1) configured to determine whether or not the moving body (vehicle 10) is in a tilted state where the moving body is inclined greater than the first predetermined tilt angle threshold TA th1 based on the tilt information obtained by the information obtainer 61. When the determiner 63 determines that the moving body is in the tilted state where the moving body is tilted greater than the first predetermined tilt angle threshold TAth1, the VR controller 67 reduces drive amounts DAsus of at least the SUS actuators 59 out of the AV device 57 and the SUS actuators 59 to amounts smaller than those in a normal state where the moving body is not in the tilted state.

Even when the moving body such as the vehicle 10 is in a stopped state on a sloped road 20 while providing the VR service, contact between the vehicle 10 (moving body) and the passerby (object) 60 can be thereby prevented.

Details of the virtual space production apparatus 11 according to the embodiment of the present invention are described below one by one.

[Schematic Configuration of Virtual Space Production Apparatus 11 According to Embodiment of Present Invention]

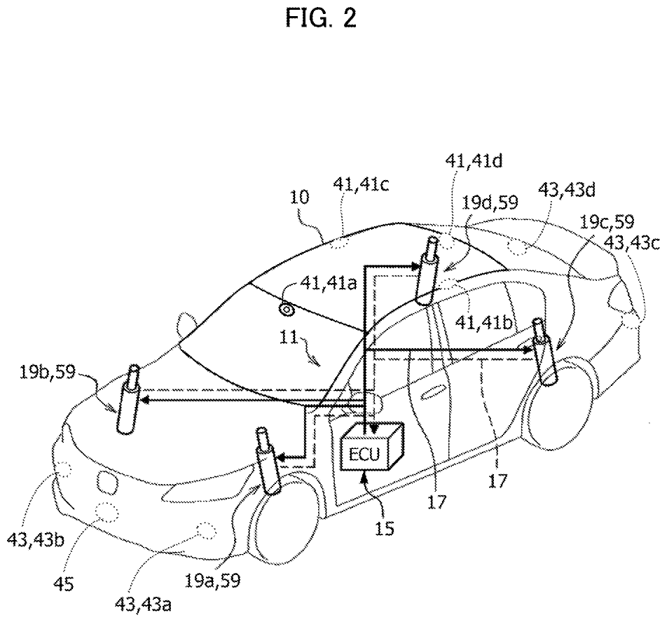

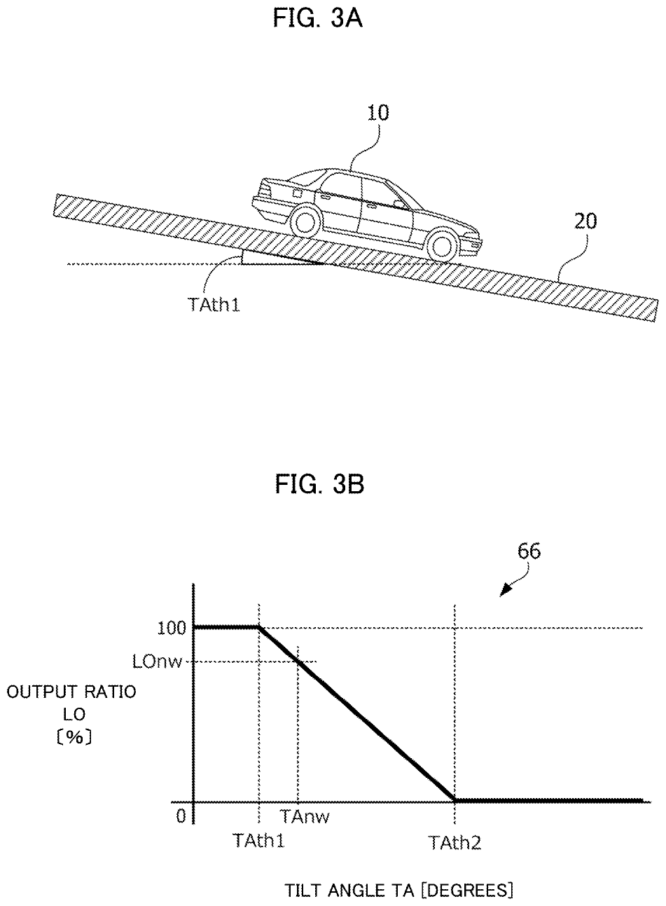

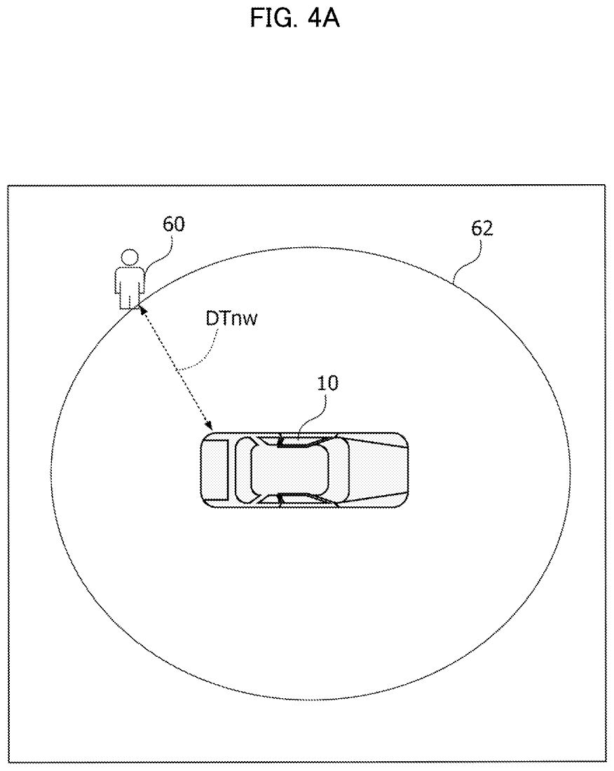

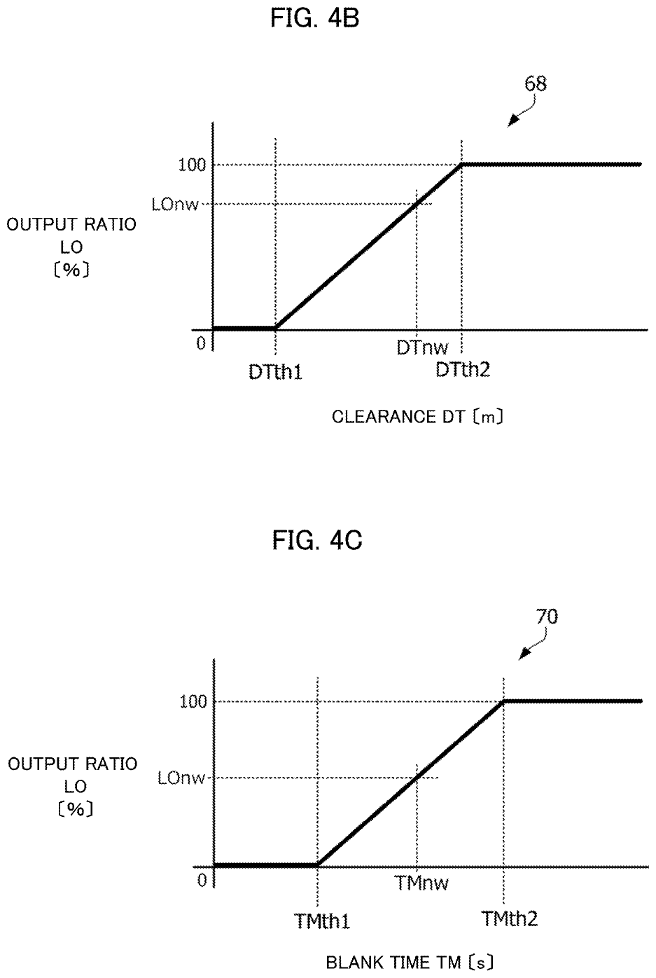

Next, a schematic configuration of the virtual space production apparatus 11 according to the embodiment of the present invention is described with reference to FIGS. 1, 2, 3A, 3B, 4A, 4B, and 4C as appropriate. FIG. 1 is a schematic configuration diagram of the virtual space production apparatus 11 according to the embodiment of the present invention. FIG. 2 is a schematic configuration diagram of the vehicle 10 to which the virtual space production apparatus 11 is applied. FIGS. 3A and 3B are diagrams used to explain operations according to an example of the virtual space production apparatus 11 in the case where the vehicle 10 is parked on a tilted road 20. FIGS. 4A and 4B are diagrams used to explain operations according to the example of the virtual space production apparatus 11 in the case where the passerby (object) 60 is present in the monitoring region 62 of the vehicle 10. FIG. 4C is a diagram used to explain operations according to the example of the virtual space production apparatus 11 in the case where a presence-absence determination result of the passerby (object) 60 in the monitoring region 62 of the vehicle 10 is reversed.

As shown in FIGS. 1 and 2, the virtual space production apparatus 11 is configured such that input-system elements 13 and output-system elements 15 are connected to one another via a communication medium 17 such as, for example, a controller area network (CAN) to allow data communication.

As shown in FIG. 1, the input-system elements 13 includes a periphery monitoring device 21, a vehicle speed sensor 23, a parking brake (PB) sensor 25, a seatbelt (SB) sensor 27, a tilt angle sensor 29, suspension (SUS) sensors 31, and a human-machine interface (HMI) 33.

Meanwhile, as shown in FIG. 1, the output-system elements 15 include a VR-ECU 51, a BRK-ECU 53, an ENG-ECU 55, the AV device 57, the suspension (SUS) actuators 59, a PB actuator 81, a door lock (DR) actuator 83, and a communication device 85.

[Schematic Configuration of Input-System Elements 13]

The periphery monitoring device 21 belonging to the input-system elements 13 monitors presence or absence of the passerby (object) 60 in the monitoring region (see refence numeral 62 shown in FIG. 4A) set in the periphery of the vehicle 10, and outputs the presence-absence information relating to presence or absence of the passerby (object) 60 in the monitoring region 62. The presence-absence information of the passerby (object) 60 in the monitoring region 62 outputted by the periphery monitoring device 21 is sent to the VR-ECU 51 and the like via the communication medium 17.

Specifically, as shown in FIGS. 1 and 2, the periphery monitoring device 21 includes cameras 41, radars 43, and a lidar 45.

As shown in FIG. 2, the cameras 41 include a front camera 41a configured to monitor an area in front of the vehicle 10, paired side cameras 41b and 41c configured to monitor areas to the left and right of the vehicle 10, respectively, and a rear camera 41d configured to monitor an area behind the vehicle 10. The cameras 41 detect and output the presence-absence information of the passerby (object) 60 present in the periphery of the vehicle 10 through peripheral images of the vehicle 10.

As shown in FIG. 2, the radars 43 are provided at four corners of the vehicle 10, respectively, and detect and output the presence-absence information of the passerby (object) 60 for the respective corner areas.

As shown in FIG. 2, the lidar 45 is provided in a front and vehicle width direction center portion of the vehicle 10, and detects and outputs the presence-absence information of the passerby (object) 60 for the area in front of the vehicle 10.

The vehicle speed sensor 23 has a function of detecting traveling speed (vehicle speed) of the vehicle 10. Information relating to the vehicle speed detected by the vehicle speed sensor 23 is sent to the BRK-ECU 53 and the like via the communication medium 17.

The parking brake (PB) sensor 25 detects and outputs an on signal when a parking brake (PB) is activated. An on-off signal outputted by the PB sensor 25 is sent to the VR-ECU 51 and the like via the communication medium 17.

The seatbelt (SB) sensor 27 detects and outputs an on signal when a seatbelt (SB) relating to a seat on which the occupant seats is fastened. An on-off signal outputted by the SB sensor 27 is sent to the VR-ECU 51 and the like via the communication medium 17.

The tilt angle sensor 29 has a function of obtaining information relating to a tilt angle of the vehicle 10. The information relating to the tilt angle of the vehicle 10 obtained by the tilt angle sensor 29 is sent to the VR-ECU 51 and the like via the communication medium 17.

The SUS sensors 31 detect and output SUS information relating to expansion-contraction states of suspension devices 19 such as sprung accelerations, upsprung accelerations, and stroke positions that are physical quantities generated with expansion and contraction operations of the suspension devices 19. The SUS information relating to the expansion-contraction states of the suspension devices 19 outputted by the SUS sensors 31 is sent to the VR-ECU 51 and the like via the communication medium 17. The VR-ECU 51 refers to the SUS information when controlling the expansion-contraction states of the suspension devices 19.

The human-machine interface (HMI) 33 includes a VR mode switch 37. The VR mode switch 37 is operated by an occupant when a virtual space is to be built in a vehicle cabin to enjoy the VR service. Operation information of the VR mode switch 37 is sent to the VR-ECU 51 and the like via the communication medium 17.

[Schematic Configuration of Output-System Elements 15]

The VR-ECU 51 belonging to the output-system elements 15 performs control relating to provision of the VR service using VR contents.

The VR-ECU 51 is formed of a microcomputer including a central processing unit (CPU), a read only memory (ROM), a random access memory (RAM), and the like. The microcomputer reads and executes programs and data stored in the ROM, and operates to perform control of executing various functions of the VR-ECU 51 including a function of obtaining various pieces of information, a determination function to be described next, a calculation function, and a VR control function.

For example, the VR-ECU 51 drives the AV device 57 and the SUS actuators 59 to reproduce a behavior and an engine sound of a kart running in a circuit or to present a video and an audio of a movie as the VR service using the VR contents. The VR contents may be, for example, downloaded in advance via the communication device 85, and stored in a memory such as the RAM included in the VR-ECU 51.

As shown in FIG. 1, the VR-ECU 51 includes the information obtainer 61, a determiner 63, a calculator 65, and the VR controller 67 to provide the VR service using the VR contents.

The information obtainer 61 obtains time-series information such as the presence-absence information of the passerby (object) 60 in the monitoring region 62 outputted by the periphery monitoring device 21, the information relating to the vehicle speed detected by the vehicle speed sensor 23, the activation information of the parking brake (PB) outputted by the PB sensor 25, the fastening information of the seatbelt (SB) outputted by the SB sensor 27, the tilt information relating to the tilt angle of the vehicle 10 outputted by the tilt angle sensor 29, the SUS information relating to the expansion-contraction states of the respective multiple suspension devices 19a, 19b, 19c, and 19d (hereinafter, collectively referred to as suspension devices 19 in some cases) outputted by the SUS sensors 31, and the operation information of the VR mode switch 37.

Various pieces of information including the presence-absence information of the object in the monitoring region 62, the information relating to the vehicle speed, the activation information of the parking brake (PB), the fastening information of the seatbelt (SB), the tilt information relating to the tilt angle of the vehicle 10, the SUS information, and the operation information of the VR mode switch 37 obtained by the information obtainer 61 are sent to the determiner 63 and the like.

The determiner 63 determines whether the vehicle 10 is in a tilted state in which the tilt angle TA of the vehicle 10 exceeds a predetermined first tilt angle threshold TAth1, based on the tilt information relating to the tilt angle TA of the vehicle 10 and obtained by the information obtainer 61. The predetermined first tilt angle threshold TAth1 is described in detail later.

Moreover, the determiner 63 determines whether the vehicle 10 is in a tilted state in which the tilt angle TA of the vehicle 10 exceeds a predetermined second tilt angle threshold TAth2, based on the tilt information relating to the tilt angle TA of the vehicle 10 and obtained by the information obtainer 61. The predetermined second tilt angle threshold TAth2 is described in detail later.

Furthermore, the determiner 63 determines whether the passerby (object) 60 is present in the monitoring region 62, based on the monitoring information obtained by the information obtainer 61.

Moreover, the determiner 63 obtains the presence information indicating that the passerby (object) 60 is present in the monitoring region 62 from the information obtainer 61, and then determines whether blank time TM in which this presence information is not obtained has exceeded a predetermined first time duration TMth1. The determination results of the determiner 63 are transmitted to the calculator 65 and the VR controller 67.

As shown in FIGS. 3A and 3B, when the determiner 63 determines that the vehicle 10 is in the tilted state in which the tilt angle TA exceeds the predetermined first tilt angle threshold TAth1 as a result of the determination after transition to the VR mode, the calculator 65 refers to a tilt angle-output ratio table 66 shown in FIG. 3B, and calculates an output ratio value LOnw corresponding to a current tilt angle value TAnw of the vehicle 10. Note that, after the transition to the VR mode, a parking attitude including the tilted state of the vehicle 10 changes from time to time during the provision of the VR service.

Accordingly, there is a practical benefit to cause the calculator 65 to refer to the tilt angle-output ratio table 66 and calculate the output ratio value LOnw corresponding to the current tilt angle value TAnw of the vehicle 10 to adjust the drive amounts DAsus of the SUS actuators 59 by using the calculated output ratio value LOnw after the transition to the VR mode.

A relationship characteristic of the tilt angle-output ratio table 66 is described in this section.

In the tilt angle-output ratio table 66 shown in FIG. 3B, a fixed value of 100% is associated as the output ratio value LO for a value range of the tilt angle TA from 0 to the first tilt angle threshold TAth1 (0≤TA≤TAth1). Note that the present embodiment employes a configuration in which, when the tilt angle TA is converged in the value range from 0 to the first tilt angle threshold TAth1 after the transition to the VR mode, the VR-ECU 51 assumes that there is no risk of a sliding-down movement of the vehicle 10, and unconditionally allows continuation of the VR mode.

Moreover, a characteristic value that gradually linearly decreases from 100% to 0% is associated as the output ratio value LO for a value range of the tilt angle TA from the first tilt angle threshold TAth1 to the second tilt angle threshold TAth2 (TAth1<TA≤TAth2). Note that the present embodiment employes a configuration in which, when the tilt angle TA ends up belonging to the value range from the first tilt angle threshold TAth1 to the second tilt angle threshold TAth2 after the transition to the VR mode, the VR-ECU 51 assumes that the risk of the sliding-down movement of the vehicle 10 is not so high, and allows continuation of the VR mode under a certain condition (with the drive amounts DAsus of the SUS actuators 59 reduced).

In other words, when the tilt angle TA belongs to the value range from the first tilt angle threshold TAth1 to the second tilt angle threshold TAth2 (the vehicle 10 is in a tilted state in which the tilt angle TA exceeds the first tilt angle threshold TAth1), the VR-ECU 51 reduces the drive amounts DAsus of the SUS actuators 59 to amounts smaller than those in the normal state in which the vehicle 10 is not in the tilted state.

A fixed value 0% is associated as the output ratio value LO for a value range of the tilt angle TA exceeding the second tilt angle threshold TAth2 (TA>TAth2). Note that the present embodiment employs a configuration in which, when the tilt angle TA exceeds the second tilt angle threshold TAth2 after the transition to the VR mode, the VR-ECU 51 assumes that the risk of the sliding-down movement of the vehicle 10 is high, and cancels continuation of the VR mode.

Next, the calculator 65 multiplies the drive amounts DAsus_st of the SUS actuators 59 in the normal state in which the vehicle 10 is not in the tilted state, by the calculated output ratio value LOnw. The calculator 65 calculates drive amounts DAsus_rd of the SUS actuators 59 after reduction depending on the current tilt angle value TAnw of the vehicle 10 (DAsus_st*LOnw=DAsus_rd).

Accordingly, when the vehicle 10 is in the tilted state in which the tilt angle TA exceeds the predetermined first tilt angle threshold TAth1, the drive amounts DAsus of the SUS actuators 59 can be reduced to amounts smaller than those in the normal state in which the vehicle 10 is not in the tilted state.

The risk of the sliding-down movement of the vehicle 10 can be thereby suppressed even when the vehicle 10 is in the tilted state in which the tilt angle TA exceeds the predetermined first tilt angle threshold TAth1.

Note that there may be employed a configuration in which, when the vehicle 10 is in the tilted state in which the tilt angle TA exceeds the predetermined first tilt angle threshold TAth1, the drive amounts DAsus of the SUS actuators 59 on the tilt direction lower side in the suspension devices 19 are reduced to amounts smaller than the drive amounts DAsus of the SUS actuators 59 on the tilt direction upper side.

This configuration can further improve the effect of suppressing the risk of the sliding-down movement of the vehicle 10 even when the vehicle 10 is in the tilted state in which the tilt angle TA exceeds the predetermined first tilt angle threshold TAth1.

Moreover, when the determiner 63 determines that the passerby (object) 60 is present in the monitoring region 62 as a result of the determination after the transition to the VR mode, the calculator 65 refers to a clearance-output ratio table 68 shown in FIG. 4B to calculate the output ratio value LOnw depending on the current clearance value DTnw between the vehicle 10 and the passerby 60.

A relationship characteristic of the clearance-output ratio table 68 is described in this section.

In the clearance-output ratio table 68 shown in FIG. 4B, a fixed value of 0% is associated as the output ratio value LO for a value range of the clearance DT from 0 to a first clearance threshold DTth1 (0≤DT≤DTth1). Note that the present embodiment employs a configuration in which, when the clearance DT ends up belonging to the value range from 0 to the first clearance threshold DTth1 after the transition to the VR mode, the VR-ECU 51 assumes that the passerby (object) 60 is present in the monitoring region 62 and a risk of contact therewith is high, and cancels continuation of the VR mode.

Moreover, a characteristic value that gradually linearly increases from 0% to 100% is associated as the output ratio value LO for a value range of the clearance DT from the first clearance threshold DTth1 to a second clearance threshold DTth2 (DTth1<DT≤DTth2). Adjusting the drive amounts DAsus of the SUS actuators 59 by using such a characteristic value provides such an action that, the smaller the clearance DT is, the larger the reduction degree relating to the drive amounts of the SUS actuators 59 is.

Note that the present embodiment employs a configuration in which, when the clearance DT ends up belonging to the value range from the first clearance threshold DTth1 to the second clearance threshold DTth2 after the transition to the VR mode, the VR-ECU 51 assumes that the passerby (object) 60 is present in the monitoring region 62 but the risk of contact therewith is not so high, and allows continuation of the VR mode under a certain condition (with the drive amounts of the SUS actuators 59 reduced).

Furthermore, a fixed value of 100% is associated as the output ratio value LO for a value range of the clearance DT exceeding the second clearance threshold DTth2 (DT>DTth2). Note that the present embodiment employs a configuration in which, when the clearance DT exceeds the second clearance threshold DTth2, the VR-ECU 51 assumes that no passerby (object) 60 is present in the monitoring region 62, and unconditionally allows the transition to the VR mode and continuation of the VR mode.

Next, the calculator 65 multiples the drive amounts DAsus_st of the SUS actuators 59 in the normal state in which no passerby (object) 60 is present in the monitoring region 62, by the calculated output ratio value LOnw. The calculator 65 calculates the drive amounts DAsus_rd of the SUS actuators 59 after reduction depending on the current clearance value DTnw between the vehicle 10 and the passerby 60 (DAsus_st*LOnw=DAsus_rd).

Accordingly, when the passerby (object) 60 is present in the monitoring region 62, the drive amounts DAsus of the SUS actuators 59 can be reduced to amounts smaller than those in the normal state in which no passerby (object) 60 is present in the monitoring region 62. As a result, the risk of the vehicle 10 contacting the passerby (object) 60 can be reduced.

Moreover, when the determiner 63 makes reverse determination that no presence information is obtained after making the determination of the object 60 being present in the monitoring region 62 as a result of the determination after the transition to the VR mode and determines that the blank time TM in which the presence information is not obtained exceeds the predetermined time duration TMth, the calculator 65 refers to a blank time-output ratio table 70 shown in FIG. 4C to calculate the output ratio value LOnw depending on the current blank time value TMnw.

A relationship characteristic of the blank time-output ratio table 70 is described in this section.

In the blank time-output ratio table 70 shown in FIG. 4C, a fixed value of 0% is associated as an output ratio value LO for a value range of a blank time accumulated value TM from 0 to a first blank time threshold TMth1 (0≤TM≤TMth1). Note that the present embodiment employs a configuration in which, when the blank time accumulated value TM belongs to the value range from 0 to the first blank time threshold TMth1 after the reverse of the presence-absence state from (present) to (absent) in the VR mode, the VR-ECU 51 determines that return to the VR mode is too early, and stands-by for the return to the VR mode.

Moreover, a characteristic value that gradually linearly increases from 0% to 100% is associated as the output ratio value LO for a value range of the blank time accumulated value TM from the first blank time threshold TMth1 to a second blank time threshold TMth2 (TMth1<TM≤TMth2). Note that the present embodiment employes a configuration in which, when the blank time accumulated value TM belongs to the value range from the first blank time threshold TMth1 to the second blank time threshold TMth2 after the reverse of the presence-absence state from (present) to (absent) in the VR mode, the VR-ECU 51 assumes that a preparation period relating to the return to the VR mode has arrived, and gradually performs the return to the VR mode.

This increases the drive amounts DAsus of the SUS actuators 59 such that the larger the blank time accumulated value TM is, the larger the drive amounts DAsus of the SUS actuators 59 are. This is because, the larger the blank time accumulated value TM is, the more the risk of the vehicle 10 contacting the passerby (object) 60 can be reduced without the reduction of the drive amounts DAsus of the SUS actuators 59.

Moreover, the fixed value of 100% is associated as the output ratio value LO for a value range of the blank time accumulated value TM exceeding the second blank time threshold TMth2 (TM>TMth2). Note that the present embodiment employs a configuration in which, when the blank time accumulated value TM belongs to the value range exceeding the second blank time threshold TMth2 after the reverse of the presence-absence state from (present) to (absent) in the VR mode, the VR-ECU 51 assumes that a return timing of the VR mode has arrived, and performs complete return to the VR mode.

Next, the calculator 65 multiples the drive amounts DAsus_st of the SUS actuators 59 in the normal state in which no object 60 is present in the monitoring region 62, by the calculated output ratio vale LOnw. The calculator 65 calculates the drive amounts DAsus_rd of the SUS actuators 59 after the reduction (increased with respect to the initial values) depending on the current blank time accumulated value TMnw (DAsus_bn*LOnw=DAsus_rd).

Accordingly, when the determiner 63 makes reverse determination that no presence information is obtained after making the determination of the object 60 being present in the monitoring region 62 and determines that the blank time accumulated value TM in which the presence information is not obtained exceeds the predetermined first blank time threshold TMth1, the drive amounts DAsus of the SUS actuators 59 are reduced (increased with respect to the initial values) to amounts smaller than those in the normal state in which no passerby (object) 60 is present in the monitoring region 62.

The VR controller 67 performs drive control of the multiple SUS actuators 59 independently, by using the drive amounts DAsus of the SUS actuators 59 (including the drive amounts DAsus_rd of the SUS actuators 59 after the reduction).

The BRK-ECU 53 belongs to the output-system elements 15 like the VR-ECU 51. As shown in FIG. 1, the BRK-ECU 53 includes an information obtainer 71 and a brake controller 73.

The BRK-ECU 53 uses drive of a brake motor to cause a motor cylinder device (for example, see JP2015-110378A: not shown) to operate depending on a level of a braking fluid (primary liquid pressure) generated in a master cylinder (not shown) by a braking operation of a driver, and thereby generates a braking liquid pressure (secondary liquid pressure) used to apply braking force to the vehicle 10.

The BRK-ECU 53 is formed of a microcomputer including a central processing unit (CPU), a read only memory (ROM), a random access memory (RAM), and the like. This microcomputer reads and executes programs and data stored in the ROM, and operates to perform control of executing various functions of the BRK-ECU 53 including a function of obtaining various pieces of information and a brake control function based on the braking operation and the like.

The information obtainer 71 has a function of obtaining various pieces of information including the information relating to the current vehicle speed detected by the vehicle speed sensor 23 and braking operation information relating to an operation amount and a step-in torque of a brake pedal (not shown) detected by a brake pedal sensor (not shown).

The brake controller 73 performs the braking control of the vehicle 10 by using drive of the braking motor to cause the motor cylinder device to operate based on the information relating to the braking operation of the driver obtained via the brake pedal sensor and the like.

The ENG-ECU 55 belongs to the output-system elements 15 like the VR-ECU 51 and the BRK-ECU 53. As shown in FIG. 1, the ENG-ECU 55 includes an information obtainer 75 and a drive controller 77.

The ENG-ECU 55 has a function of performing drive control of an internal combustion engine (not shown) based on information such as information relating to an acceleration operation (step-in amount of an accelerator pedal) of the driver obtained via an accelerator pedal sensor (not shown).

Specifically, the ENG-ECU 55 performs the drive control of the internal combustion engine by controlling a throttle valve configured adjust an air intake amount of the internal combustion engine, an injector (not shown) configured to inject a fuel gas, ignition plugs (not shown) configured to ignite the fuel, and the like.

The ENG-ECU 55 is formed of a microcomputer including a central processing unit (CPU), a read only memory (ROM), a random access memory (RAM), and the like. This microcomputer reads and executes programs and data stored in the ROM, and operates to perform control of executing various functions of the ENG-ECU 55 including a function of obtaining various pieces of information and a drive control function of the internal combustion engine.

The information obtainer 75 has a function of obtaining various pieces of information including acceleration-deceleration operation information relating to the operation amount of the accelerator pedal detected by the accelerator pedal sensor.

The drive controller 77 performs the drive control of the internal combustion engine based on information such as the information relating to the acceleration operation (step-in amount of the accelerator pedal) of the driver obtained via the accelerator pedal sensor.

The AV device 57 includes a display device, an audio device, an AV reproduction device, and the like. The AV device 57 is driven by the VR control function of the VR-ECU 51.

The SUS actuators 59 are provided in the respective suspension devices 19a, 19b, 19c, and 19d provided for the respective wheels of the vehicle 10. Each of the multiple SUS actuators 59 is provided parallel to a spring member (not shown) provided between a sprung member (vehicle body) (not shown) of the vehicle 10 and an upsprung member (wheel or the like to which a tire is fitted) (not shown).

The SUS actuators 59 have a role as virtual dampers that cushion stretching force of the spring members in traveling of the vehicle 10. Meanwhile, in a scene in which the VR service is provided by using the vehicle 10 as a motion platform, the SUS actuators 59 have a role of providing realistic sensations to the occupant in the virtual space.

The parking brake (PB) actuator 81 has a function of driving the PB provided in the vehicle 10. The PB actuator 81 is turned on and driven by the VR control function of the VR-ECU 51 when the occupant performs an operation of turning on the VR mode switch 37.

The door lock (DR) actuator 83 has a function of driving a DR included in the vehicle 10. The DR actuator 83 is turned on and driven (locks the doors) by the VR control function of the VR-ECU 51 when the occupant performs the operation of turning on the VR mode switch 37.

The communication device 85 is used, for example, when necessary data and information are obtained from the outside of the vehicle 10.

[Definition of Terms Used in Present Specification]

The terms used in the present specification are defined.

The tilted state of the vehicle 10 means a parking attitude comprehensively including a state in which the vehicle 10 is tilted in a vehicle longitudinal direction of the vehicle 10, a state in which the vehicle 10 is tilted in a vehicle width direction of the vehicle 10, and a tilted state being a combination of these states.

The “predetermined first tilt angle threshold TAth1” refers to a critical tilt angle at which there is no risk of the sliding-down movement of the vehicle 10 during the provision of the VR service performed with the vehicle 10 used as the motion platform. The value of the first tilt angle threshold TAth1 generally varies depending on the attributes including the type, the weight, and the position of the center of gravity of the vehicle 10 and the like. Accordingly, the first tilt angle threshold TAth1 only needs to be set to an appropriate value depending on the attributes including the type, the weight, and the position of the center of gravity of the vehicle 10 and the like.

The “predetermined second tilt angle threshold TAth2” refers to a critical tilt angle at which the risk of the sliding-down movement of the vehicle 10 during the provision of the VR service performed with the vehicle 10 used as the motion platform can be assumed to be high. The value of the second tilt angle threshold TAth2 generally varies depending on the attributes including the type, the weight, and the position of the center of gravity of the vehicle 10 and the like, like the first tilt angle threshold TAth1. Accordingly, the second tilt angle threshold TAth2 only needs to be set to an appropriate value depending on the attributes including the type, the weight, and the position of the center of gravity of the vehicle 10 and the like.

[Operations of Virtual Space Production Apparatus 11 According to Embodiment]

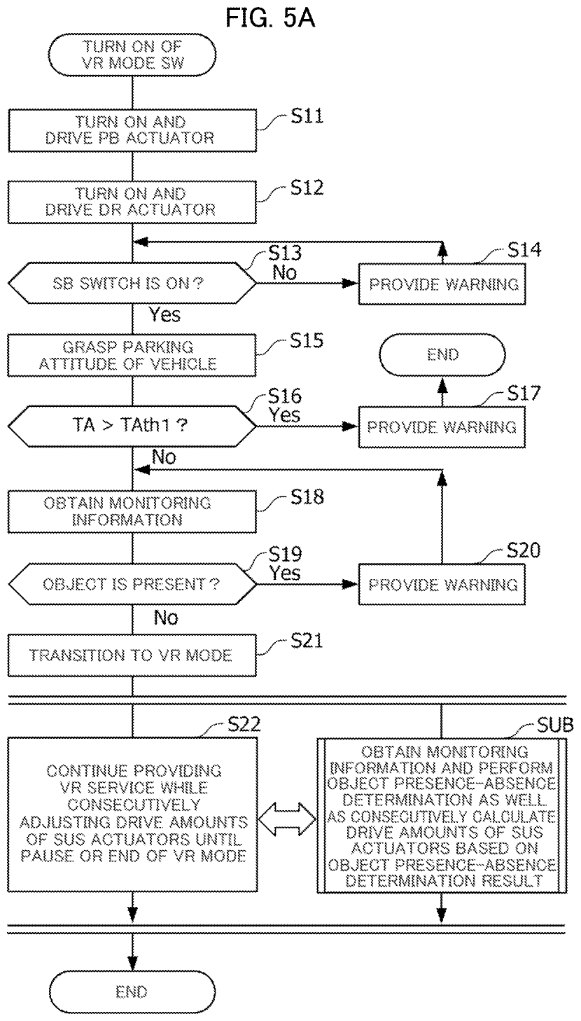

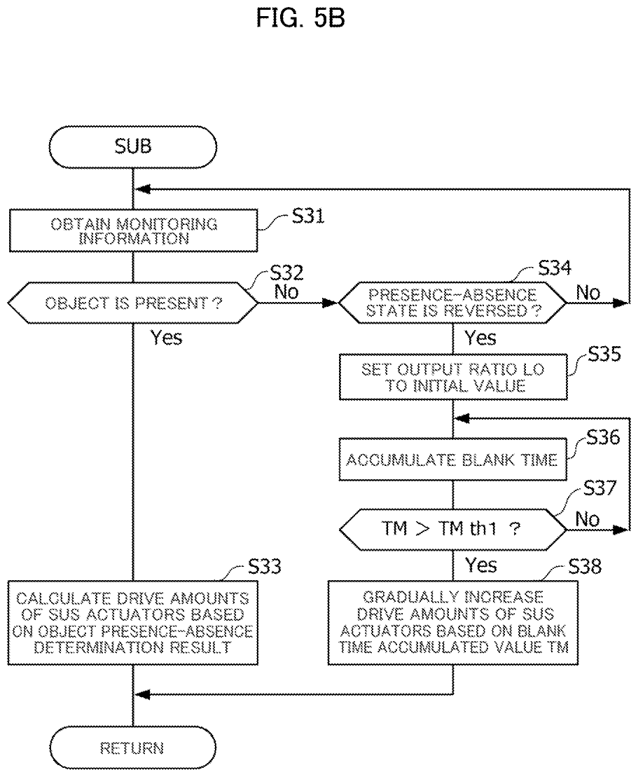

Next, operations of the virtual space production apparatus 11 according to the embodiment are described with reference to FIGS. 5A and 5B. FIGS. 5A and 5B are flowcharts used to explain the operations of the virtual space production apparatus 11 according to the embodiment.

It is assumed that the vehicle 10 is in a stopped state and the occupant has performed the operation of turning on the VR mode switch 37.

In steps S11 to S12 shown in FIG. 5A, the VR-ECU 51 turns on and drives the PB actuator 81 and the DR actuator 83. This maintains the parked state of the vehicle 10 and locks the doors.

In step S13, the VR-ECU 51 checks whether the seatbelt (SB) switch is on, that is whether the occupant is in a restrained state by fastening the seatbelt.

When the VR-ECU 51 determines that the occupant is not in the restrained state by fastening the seatbelt as a result of the check in step S13 (No in step S13), the VR-ECU 51 causes the flow of processes to proceed to subsequent step S14.

Meanwhile, when the VR-ECU 51 determines that the occupant is in the restrained state by fastening the seatbelt as a result of the check in step S13 (Yes in step S13), the VR-ECU 51 causes the flow of processes to jump to step S15.

In step S14, the VR-ECU 51 provides a warning prompting the occupant to fasten the seatbelt, by using the AV device 57. Thereafter, the VR-ECU 51 causes the flow of processes to return to step S13, and performs the subsequent processes.

In step S15, the information obtainer 61 of the VR-ECU 51 grasps the parking attitude of the vehicle 10 based on the tilt information relating to the tilt angle of the vehicle 10 and detected by the tilt angle sensor 29.

In step S16, the determiner 63 of the VR-ECU 51 determines whether the vehicle 10 is in the tilted state in which the tilt angle TA exceeds the first tilt angle threshold TAth1, based on the tilt information relating to the tilt angle TA of the vehicle 10 obtained by the information obtainer 61.

When the determiner 63 determines that the vehicle 10 is in the tilted state in which the tilt angle TA exceeds the first tilt angle threshold TAth1 as a result of the determination in step S16 (Yes in step S16), the VR-ECU 51 causes the flow of processes to proceed to subsequent step S17.

Meanwhile, when the determiner 63 determines that the vehicle 10 is not in the tilted state in which the tilt angle TA exceeds the first tilt angle threshold TAth1 as a result of the determination in step S16 (No in step S16), the VR-ECU 51 assumes that there is no risk of the sliding-down movement of the vehicle 10 even if the transition to the VR mode is allowed regarding the parking attitude of the vehicle 10, and causes the flow of processes to jump to step S18.

In step S17, the VR-ECU 51 provides a warning prompting the occupant to move the vehicle 10 to a flat road and then reactivate the VR mode (performed by resetting of the VR mode switch 37), by using the AV device 57. Then, the VR-ECU 51 terminates the flow of the series of processes.

In step S18, the information obtainer 61 of the VR-ECU 51 obtains the monitoring information outputted by the periphery monitoring device 21 and including presence or absence of the passerby (object) 60 in the monitoring region 62.

In step S19, the determiner 63 of the VR-ECU 51 determines whether the passerby (object) 60 is present in the monitoring region 62 based on the monitoring information obtained by the information obtainer 61.

When the determiner 63 determines that the passerby (object) 60 is present in the monitoring region 62 as a result of the determination in step S19 (Yes in step S19), the VR-ECU 51 causes the flow of processes to proceed to subsequent step S20.

Meanwhile, when the determiner 63 determines that the passerby (object) 60 is absent in the monitoring region 62 as a result of the determination in step S19 (No in step S19), the VR-ECU 51 causes the flow of processes to jump to step S21.

In step S20, the VR-ECU 51 provides a warning rejecting transition to the VR mode due to presence of the passerby (object) 60 in the monitoring region 62, by using the AV device 57. Then, the VR-ECU 51 causes the flow of processes to return to step S18, and performs the subsequent processes.

In step S21, the VR-ECU 51 assumes that there is no risk of contact between the vehicle 10 and the passerby (object) 60 even if the transition to the VR mode is allowed, and allows the transition to the VR mode. The vehicle 10 thereby turns into an entertainment facility in which the vehicle 10 is used as the motion platform.

In step S22, the VR-ECU 51 continues providing the VR service while consecutively adjusting the drive amounts of the SUS actuators 59 until pause or end of the VR mode.

Meanwhile, in a sub-routine SUB (VR mode), the VR-ECU 51 obtains the monitoring information and performs the object presence-absence determination as well as performs a process of consecutively calculating the drive amounts of the SUS actuators 59 based on the object presence-absence determination result, in parallel with the process of step S22.

Specifically, in step S31 of the sub-routine (VR mode) shown in FIG. 5B, the information obtainer 61 of the VR-ECU 51 obtains the monitoring information outputted by the periphery monitoring device 21 and including presence or absence of the passerby (object) 60 in the monitoring region 62.

In step S32, the determiner 63 of the VR-ECU 51 determines whether the passerby (object) 60 is present in the monitoring region 62 based on the monitoring information obtained by the information obtainer 61.

When the determiner 63 determines that the passerby (object) 60 is present in the monitoring region 62 (the clearance DT is equal to or smaller than the second clearance threshold DTth2) as a result of the determination in step S32 (Yes in step S32), the VR-ECU 51 causes the flow of processes to proceed to subsequent step S33.

Meanwhile, when the determiner 63 determines that the passerby (object) 60 is absent in the monitoring region 62 (the clearance DT exceeds the second clearance threshold DTth2) as a result of the determination in step S32 (No in step S32), the VR-ECU 51 causes the flow of processes to jump to step S34.

In step S33, the VR-ECU 51 calculates the drive amounts DAsus of the SUS actuators 59 based on the object presence-absence determination result.

The VR-ECU 51 continues providing the VR service in step S22 shown in FIG. 5A by using the drive amounts DAsus of the SUS actuators 59 calculated as described above.

In step S33, the VR-ECU 51 calculates the drive amounts DAsus of the SUS actuators 59 based on the object presence-absence determination result (with reference to the clearance-output ratio table 68 shown in FIG. 4B). Then, the VR-ECU 51 causes the flow of processes to return to step S31, and performs the subsequent processes until the VR mode is terminated by, for example, a turn-off operation of the VR mode switch 37.

In step S34, the VR-ECU 51 determines whether the presence-absence state in the VR mode is reversed from (present) to (absent). In step S34, the case where the determiner 63 determines that the passerby 60 is present in the monitoring region 62 in step S32 (Yes in step S32) and then determines that the passerby 60 is absent is assumed to be the case where the VR-ECU 51 determines that the presence-absence state in the VR mode is reversed. Note that the flowcharts shown in FIGS. 5A and 5B are for schematically describing the flow of processes of the present invention.

When the VR-ECU 51 determines that the presence-absence state in the VR mode is not reversed from (present) to (absent) as a result of the determination in step S34 (No in step S34), the VR-ECU 51 causes the flow of processes to return to step S31, and performs the subsequent processes until the VR mode is terminated by, for example, the turn-off operation of the VR mode switch 37.

Meanwhile, when the VR-ECU 51 determines that the presence-absence state in the VR mode is reversed from (present) to (absent) as a result of the determination in step S34 (Yes in step S34), the VR-ECU 51 causes the flow of processes to proceed to subsequent step S35.

In step S35, the VR-ECU 51 sets the output ratio value LO to (0%) which is an initial value.

In step S36, the VR-ECU 51 obtains the blank time accumulated value TM by accumulating the blank time.

In step S37, the VR-ECU 51 determines whether the blank time accumulated value TM has exceeded the first blank time threshold TMth1 (see FIG. 4C).

When the VR-ECU 51 determines that the blank time accumulated value TM has not exceeded the first blank time threshold TMth1 as a result of the determination in step S37 (No in step S37), the VR-ECU 51 causes the flow of processes to return to step S36, and causes the processes of (step S36 to step S37) to loop as long as the reverse of the presence-absence state in the VR mode continues (the absent state continues). The VR-ECU 51 performs the subsequent processes until the VR mode is terminated by, for example, the turn-off operation of the VR mode switch 37.

Meanwhile, when the VR-ECU 51 determines that the blank time accumulated value TM has exceeded the first blank time threshold TMth1 as a result of the determination in step S37 (Yes in step S37), the VR-ECU 51 causes the flow of processes to proceed to subsequent step S38.

In step S38, the VR-ECU 51 calculates the drive amounts DAsus of the SUS actuators 59 based on the blank time accumulated value TM (with reference to the blank time-output ratio table 70 shown in FIG. 4C). In this case, the VR-ECU 51 reduces the drive amounts DAsus of the SUS actuators 59 (increases with respect to initial values) to amounts smaller than those in the normal state in which the passerby (object) 60 is absent in the monitoring region 62.

In other words, the drive amounts DAsus of the SUS actuators 59 increase (gradually increase) as the blank time accumulated value TM increases. This is because, since the risk of contact between the vehicle 10 and the passerby (object) 60 decreases as the blank time accumulated value TM increase, a request for suppressing the drive amounts DAsus of the SUS actuators 59 decreases.

Note that there may be employed a configuration in which an increase amount relating to the drive amounts DAsus of the SUS actuators 59 based on the blank time accumulated value TM is updated, for example, every time a predetermined period elapses in a section where the blank time continues.

Then, the VR-ECU 51 causes the flow of processes to return to step S32, and performs the subsequent processes until the VR mode is terminated by, for example, the turn-off operation of the VR mode switch 37.

[First Modified Example of Virtual Space Production Apparatus 11]

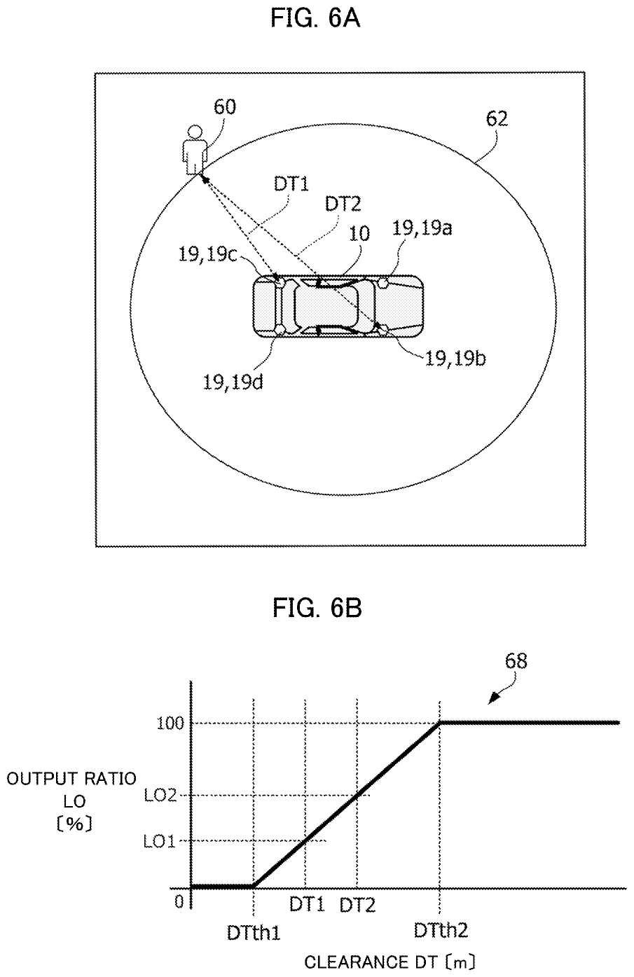

Next, a first modified example of the virtual space production apparatus 11 is described with reference to FIGS. 6A and 6B. FIG. 6A and 6B are diagrams used to explain operations according to the first modified example of the virtual space production apparatus 11 in the case where the passerby (object) 60 is present in the monitoring region 62 of the vehicle 10 after the transition to the VR mode.

In the first modified example of the virtual space production apparatus 11, in the case where the passerby (object) 60 is present in the monitoring region 62 of the vehicle 10 after the transition to the VR mode as shown in FIG. 6A, output ratio values LO for the respective multiple suspension devices 19a, 19b, 19c, and 19d included in the vehicle 10 are calculated based on magnitude relationships of the clearances DT of the respective multiple suspension devices 19a, 19b, 19c, and 19d with the passerby (object) 60.

In the example shown in FIG. 6A and 6B, a clearance DT1 between the passerby (object) 60 and the rear left suspension device 19c of the vehicle 10 is smaller than a clearance DT2 between the passerby (object) 60 and the front right suspension device 19b of the vehicle 10 (DT1<DT2).

With reference to the clearance-output ratio table 68 shown in FIG. 6B, an output ratio value LO1 corresponding to the clearance DT1 is smaller than an output ratio value LO2 corresponding to the clearance DT2 (LO1<LO2).

As a result, the drive amount DAsus of the SUS actuator 59 included in the rear left suspension device 19c of the vehicle 10 is smaller than the drive amount DAsus of the SUS actuator 59 included in the front right suspension device 19b of the vehicle 10.

In other words, according to the first modified example of the virtual space production apparatus 11, the drive amount DAsus of the SUS actuator 59 included in the suspension device 19c whose clearance DT with the passerby (object) 60 is smaller is reduced more than the drive amount DAsus of the SUS actuator 59 included in the suspension device 19b whose clearance DT with the passerby (object) 60 is larger than the clearance DT of the suspension device 19c. Accordingly, the risk of the vehicle 10 contacting the passerby (object) 60 can be suppressed.

[Second Modified Example of Virtual Space Production Apparatus 11]

Next, a second modified example of the virtual space production apparatus 11 is described with reference to FIG. 5A.

In the second modified example of the virtual space production apparatus 11, in step S16 shown in FIG. 5A, the second tilt angle threshold TAth2 is applied as the determination threshold instead of the first tilt angle threshold TAth1. In other words, the determiner 63 of the VR-ECU 51 determines whether the vehicle 10 is in the tilted state in which the tilt angle TA exceeds the second tilt angle threshold TAth2, based on the tilt information relating to the tilt angle TA of the vehicle 10 and obtained by the information obtainer 61.

When the determiner 63 determines that the vehicle 10 is in the tilted state in which the tilt angle TA exceeds the second tilt angle threshold TAth2 as a result of the determination in step S16 (Yes in step S16), the VR-ECU 51 assumes that the risk of the sliding-down movement of the vehicle 10 during provision of the VR service performed with the vehicle 10 used as a motion platform is high, and causes the flow of processes to proceed to subsequent step S17.

Meanwhile, when the determiner 63 determines that the vehicle 10 is not in the tilted state in which the tilt angle TA exceeds the second tilt angle threshold TAth2 as a result of the determination in step S16 (No in step S16), the VR-ECU 51 assumes that the risk of the sliding-down movement of the vehicle 10 is not so high even if the transition to the VR mode is allowed regarding the parking attitude of the vehicle 10, and causes the flow of processes to jump to step S18.

In step S17, the VR-ECU 51 provides a warning prompting the occupant to move the vehicle 10 to a flat road and then reactivate the VR mode (performed by resetting of the VR mode switch 37), by using the AV device 57. Then, the VR-ECU 51 terminates the flow of the series of processes.

In steps S18 to S21, the VR-ECU 51 performs processes similar to those in the above-mentioned example.

In step S22, the VR-ECU 51 continues providing the VR service while consecutively adjusting the drive amounts of the SUS actuators 59 until the pause or end of the VR mode.

In this case, it is known that the vehicle 10 is not in the tilted state in which the tilt angle TA exceeds the second tilt angle threshold TAth2 (TA≤TAth2) based on the determination result of step S16 according to the second modified example.

When the tilt angle TA has converged in a value range from 0 to the first tilt angle threshold TAth1 (0≤TA≤TAth1) in such cases, the fixed value of 100% is associated as the output ratio value LO for this value range (0≤TA≤TAth1) with reference to the tilt angle-output ratio table 66 shown in FIG. 3B.

Accordingly, when the tilt angle TA has converged in the value range (0≤TA≤TAth1), the VR-ECU 51 assumes that there is no risk of sliding-down movement of the vehicle 10, and unconditionally allows continuation of the VR mode without reducing the drive amounts DAsus of the SUS actuators 59.

Meanwhile, when the tilt angle TA belongs to the value range from the first tilt angle threshold TAth1 to the second tilt angle threshold TAth2 (TAth1≤TA≤TAth2), the characteristic value that gradually linearly decreases from 100% to 0% is associated as the output ratio value LO for this value range (TAth1≤TA≤TAth2).

Accordingly, when the tilt angle TA belongs to this value range (TAth1≤TA≤TAth2), the VR-ECU 51 assumes that the risk of sliding-down movement of the vehicle 10 is not so high, and allows continuation of the VR mode under a certain condition (with the drive amounts DAsus of the SUS actuators 59 appropriately reduced).

Note that, in step S22, the VR-ECU 51 continues providing the VR service while consecutively adjusting the drive amounts of the SUS actuators 59 based on the presence or absence of the object and the tilted attitude of the vehicle 10 until the pause or end of the VR mode.

According to the second modified example of the virtual space production apparatus 11, the drive amounts DAsus of the SUS actuators 59 included in the suspension devices 19 are adjusted depending on the parking attitude of the vehicle 10. Accordingly, it is possible to reduce the risk of sliding-down movement of the vehicle 10 and also further improve the effect of suppressing the risk of the vehicle 10 contacting the passerby (object) 60 with the sliding-down movement of the vehicle 10.

### Other Embodiments

The multiple embodiments described above describe specific examples of the present invention. Accordingly, the technical scope of the present invention should not be interpreted to be limited by these embodiments. This is because the present invention can be carried out in various modes without departing from the gist or the main feature of the present invention.

For example, although the embodiment of the present invention is described by giving, as an example, the configuration in which the drive amounts DAsus of the SUS actuators 59 included in the suspension devices 19 are reduced to suppress the risk of the vehicle 10 contacting the passerby (object) 60, the present invention is not limited to this example.

For example, instead of the configuration in which the drive amounts DAsus of the SUS actuators 59 included in the suspension devices 19 are reduced or in addition to this configuration, there may be employed a configuration in which a high-frequency band in frequency characteristics relating to a drive pattern of the SUS actuator 59 is suppressed to suppress the risk of the vehicle 10 contacting the passerby (object) 60.

Moreover, although the embodiment of the present invention is described by giving, as an example, the mode in which the operation control according to the present invention is performed by using the VR-ECU 51 that functions independently of the other ECUs, the present invention is not limited to this example. A mode in which the operation control according to the present invention is performed by using an integrated ECU in which multiple functions are integrated may be employed.

Moreover, there may be employed a configuration in which, when the operation control according to the present invention is performed by using the integrated ECU, software that can execute the operation control according to the present invention and that is stored in an external server (not shown) is downloaded to a memory included in the integrated ECU via the communication device 85, and is executed to execute the operation control according to the present invention by using the integrated ECU.

What is claimed is:

1. A virtual space production apparatus comprising:
an audio visual (AV) device configured to provide AV information to an occupant of a moving body;
an actuator configured to generate load relating to vibration of the moving body; and
a controller configured to control the AV device and the actuator, wherein the virtual space production apparatus produces a simulated experience for the occupant in a virtual space by driving the AV device and the actuator when providing a virtual reality (VR) service by using the moving body in a stopped state, the virtual space production apparatus further comprising:
an information obtainer configured to obtain tilt information indicating tilt angle of the moving body, and
a determiner configured to determine whether or not the moving body is in a tilt state where the moving body is tilted greater than a predetermined tilt angle threshold, based on the tilt information indicating the tilt angle of the moving body, wherein
when the determiner determines the moving body is in a tilted state where the moving body is tilted greater than the predetermined tilt angle threshold, the controller reduces a drive amount of at least the actuator out of the AV device and the actuator to an amount smaller than that in a normal state where the vehicle body is not in the tilted state.

2. The virtual space production apparatus according to claim 1, wherein
the moving body is a vehicle with four wheels,
the actuator has a function of assisting an expansion-contraction operation of a suspension device provided for each of the four wheels, and
when the vehicle is in the tilted state where the vehicle is tilted greater than the predetermined tilted angle threshold, the controller reduces the drive amount of the actuator located on a side to which the vehicle is tilted less than the drive amount of the actuator located on a side oppose to the side to which the vehicle is tilted.
